(19) United States
(12) Patent Application Publication
(10) Pub. No.: US 2023/0173988 A1
(43) Pub. Date: Jun. 8, 2023

(54) COLLAPSIBLE RAMP ASSEMBLY

(71) Applicant: Brian Goldwitz, Orange, CT (US)

(72) Inventor: Brian Goldwitz, Orange, CT (US)

(21) Appl. No.: 18/103,980

(22) Filed: Jan. 31, 2023

Related U.S. Application Data
(63) Continuation of application No. 16/578,220, filed on Sep. 20, 2019.
(60) Provisional application No. 62/734,463, filed on Sep. 21, 2018.
(60) Provisional application No. 62/747,574, filed on Oct. 18, 2018.
(60) Provisional application No. 62/775,793, filed on Dec. 5, 2018.
(60) Provisional application No. 62/786,226, filed on Dec. 28, 2018.

(51) Int. Cl. B60R 7/02; B65D 71/20; B60R 5/04; B60R 13/01; B60R 9/06; B60R 11/06

(52) U.S. Cl. CPC B60R 7/02; B65D 71/20; B60R 5/04; B60R 13/01; B60R 9/065; B60R 11/06

(57) ABSTRACT

Ramp assemblies may include a first ramp member and a second ramp member configured to telescope relative to the first ramp member. The first ramp member may include a first top panel. The second ramp member may include a second top panel, a housing below the second top panel, and a rod coupled to the second top panel with the rod extending from the second top panel into the housing. Methods of making such ramp assemblies, and methods of using such ramp assemblies are also disclosed. Other aspects, embodiments, and features are also included.

### PRIORITY CLAIM

This application is a continuation of, and claims priority to and the benefit of co-pending nonprovisional patent application Ser. No. 16/578,220 filed in the U.S. Patent and Trademark Office on Sep. 20, 2019, which claims priority to and the benefit of U.S. provisional patent application No. 62/734,463 filed in the U.S. Patent and Trademark Office on Sep. 21, 2018, U.S. provisional patent application No. 62/734,474 filed in the U.S. Patent and Trademark Office on Sep. 21, 2018, U.S. provisional patent application No. 62/747,574 filed in the U.S. Patent and Trademark Office on Oct. 18, 2018, U.S. provisional patent application No. 62/775,793 filed in the U.S. Patent and Trademark Office on Dec. 5, 2018, and U.S. provisional patent application No. 62/786,226 filed in the U.S. Patent and Trademark Office on Dec. 28, 2018, the entire content of all of the above being incorporated herein by reference as if fully set forth below in their entireties and for all applicable purposes.

### TECHNICAL FIELD

The technology discussed below relates generally to automotive features, and more specifically to loading and offloading ramps for automotive vehicles.

### BACKGROUND

The moving, hauling, and transporting of heavy equipment, items and recreational vehicles is a common occurrence in today's society. Such equipment, items, and recreational vehicles can include wheelchairs, furniture with casters, ATVs, roto tillers, lawn tractors, heavy duty mowers, motorcycles, dirt bikes, skidoos, etc. Furthermore, such heavy equipment is most often loaded onto the beds of pickup trucks and, less often, into the storage compartments of SUVs and minivans.

Typically, the loading and unloading of the equipment is accomplished in one of two ways: either one or more individuals manually lifts up the piece of equipment, for example, and with difficulty maneuvers the piece of equipment into the storage compartment or onto the bed of the vehicle; or makeshift ramps, such as a pair of two by eights or a pair of two by tens are propped against the rear ledge or open tailgate of the vehicle. The piece of equipment is then pushed up the ramp and pushed into the rear storage compartment or on the bed of the vehicle.

The dangers and difficulties of loading and unloading such equipment are obvious. Lifting an ATV or a lawn tractor on and off the bed of a vehicle is hard, dangerous, and unsafe. Serious injury could result to all members of a party involved in lifting the equipment should even one member of the party lose his grip on the equipment. In addition, the above-mentioned types of equipment are bulky, awkward, and not even designed to be lifted, loaded, and unloaded from one surface to another surface having a different elevation from the first surface.

The dangers and difficulties are not avoided by using makeshift planks as ramps. The individuals still must push with great exertion the piece of equipment up the planks all the while maintaining the alignment of the wheels, rollers, casters, or skids with the planks so that the piece of equipment doesn't roll off the planks. In addition, in order to unload the piece of equipment, the moving party must first align the piece of equipment with the planks, and then simultaneously restrain and allow the downward sliding or rolling motion of the piece of equipment. Again, should the piece of equipment roll off the planks or get away from the moving party, serious damage to the equipment and serious injury to the members of the moving party could occur. In view of the above, there is a definite need for a more secure, convenient, safe, and solid system or assembly for loading and unloading all types of heavy, awkward equipment on and off of transport and hauling vehicles.

Accordingly, it may be desirable to provide ramp assemblies for pickup trucks, trucks, and vehicles in general with improved use and storage capabilities.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure related to collapsible ramps. At least one aspect of the present disclosure includes ramp assemblies. According to at least one embodiment, a ramp assembly may include a first ramp member and a second ramp member configured to telescope relative to the first ramp member. The first ramp member may include a first top panel. The second ramp member may include a second top panel, a housing below the second top panel, and a rod coupled to the second top panel with the rod extending from the second top panel into the housing.

Further aspects of the present disclosure include methods of making ramp assemblies. According to one or more embodiments, such methods may include forming a first ramp member including a first top panel. A second ramp member may be formed to include a second top panel, a housing below the second top panel, and a rod coupled to the second top panel, the rod extending from the second top panel into the housing. The second ramp member may be coupled to the first ramp member to telescope into and out from the first ramp member.

Additional aspects of the present disclosure include methods of using a ramp assembly. According to one or more embodiments, such methods may include extending a plurality of ramp members in telescoping fashion. Each ramp member may be locked in the extended position by positioning a respective top panel associated with each ramp member against a respective top surface. A top panel may be displaced away from the top surface for at least one ramp member. The at least one ramp member may be telescoped into another ramp member, where the top panel of the at least one ramp member is positioned over the top panel of the other ramp member into which the at least one ramp member is telescoped.

Other aspects, features, and embodiments associated with the present disclosure will become apparent to those of ordinary skill in the art upon reviewing the following description in conjunction with the accompanying figures.

### DRAWINGS

FIG. 1 is an isometric view of a rear of a vehicle with a collapsible ramp assembly coupled to a closed tailgate according to at least one embodiment of the present disclosure.

FIG. 2 is an isometric view of a rear of a vehicle with a collapsible ramp assembly coupled to an open tailgate according to at least one embodiment of the present disclosure.

FIG. 3 is an isometric view of a rear of a vehicle with a collapsible ramp assembly coupled to an open tailgate according to at least one embodiment of the present disclosure.

FIG. 4 is an elevation view of a portion of a vehicle with a collapsible ramp assembly coupled to an open tailgate, the top image showing the collapsible ramp assembly extended to a use configuration, and the bottom image showing the collapsible ramp assembly resting on the ground according to at least one embodiment of the present disclosure.

FIG. 5 is a side view of the collapsible ramp assembly in its collapsed configuration according to at least one embodiment of the present disclosure.

FIG. 6 is a side view of the collapsible ramp assembly in its extended configuration prior to locking the panels into place according to at least one embodiment of the present disclosure.

FIG. 7 is a side view of the collapsible ramp assembly in its extended configuration after locking the panels into place according to at least one embodiment of the present disclosure.

### DETAILED DESCRIPTION

The illustrations presented herein are, in some instances, not actual views of any particular ramp assembly or vehicle, but are merely idealized representations which are employed to describe one or more aspects of the present disclosure. Additionally, elements common between figures may retain the same numerical designation.

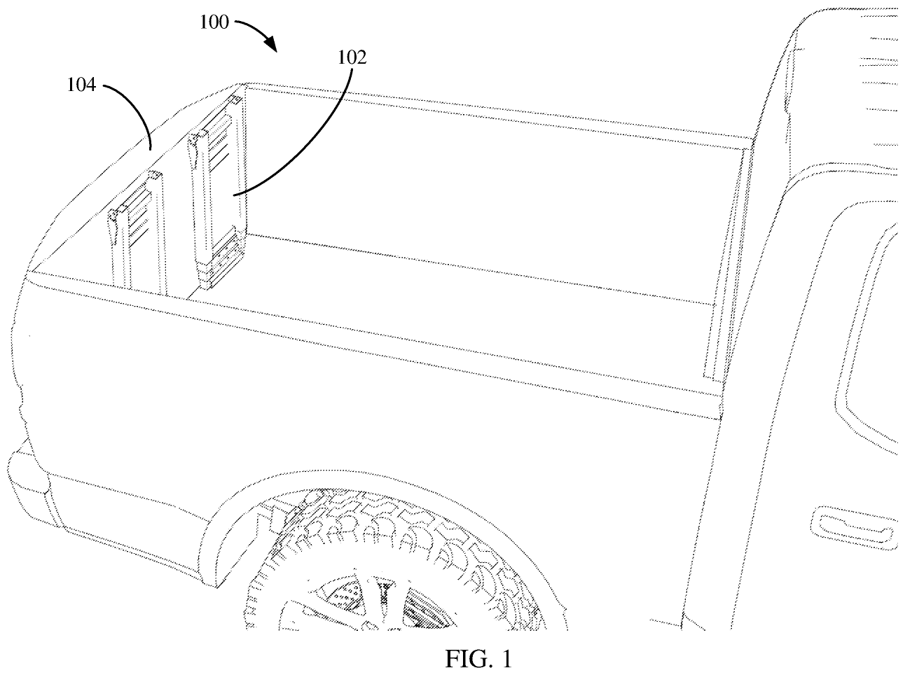

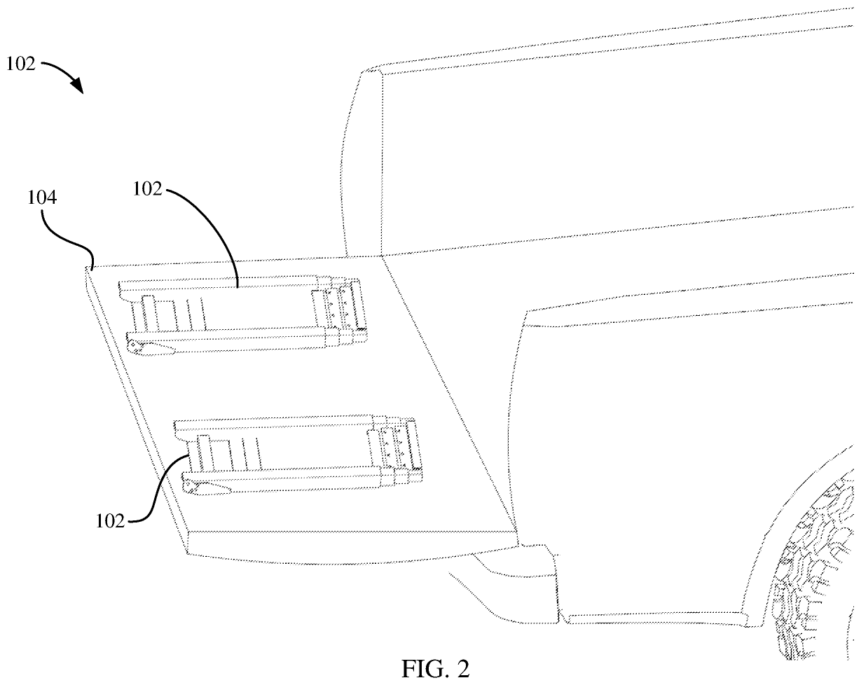

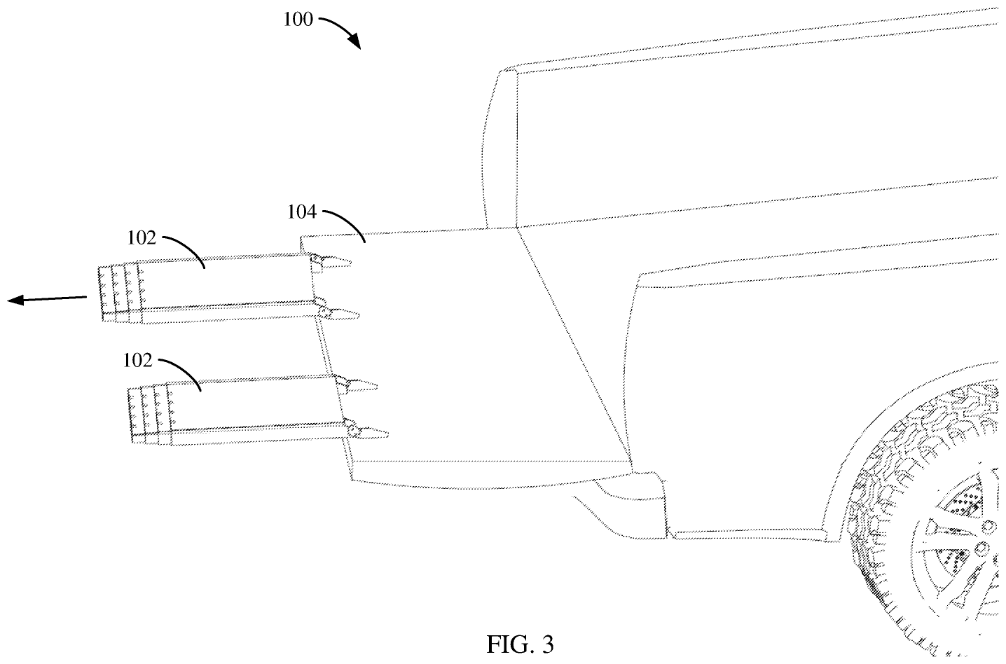

Aspects of the present disclosure a telescoping ramp assembly. FIG. 1 shows a partial isometric view of a rear of a vehicle 100 with a pair of collapsible ramp assemblies 102 coupled to a closed tailgate 104 according to at least one embodiment of the present disclosure. FIG. 2 shows a partial isometric view of a rear of the vehicle 100 with the pair of collapsible ramp assemblies 102 coupled to the opened tailgate 104 according to at least one embodiment of the present disclosure. FIG. 3 shows the pair of collapsible ramp assemblies 102 hinged outward from the tailgate 104 according to at least one embodiment. Although the ramp assemblies 102 are shown coupled to the tailgate 104, it will be apparent that the ramp assemblies 102 may operate in an uncoupled manner, where a ramp assembly 102 may be placed against a lower surface and an upper surface to facilitate movement of an object or animal between the two surfaces.

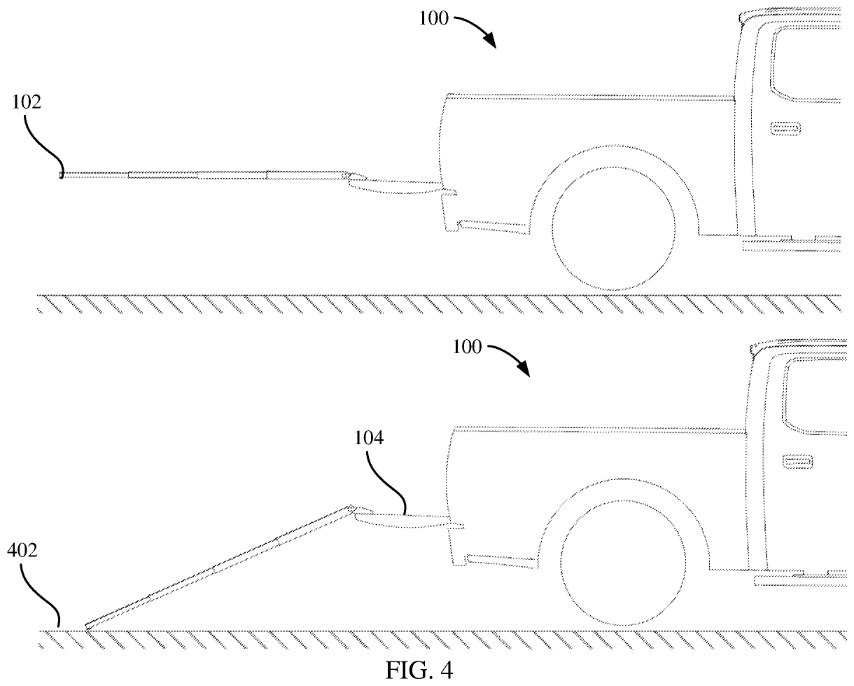

According to an aspect of the present disclosure, the collapsible ramp assemblies 102 are configured to telescope outward in the direction of the arrow in FIG. 3. FIG. 4 shows a side view of the vehicle 100 with a ramp assembly 102 telescoped outward for use. After a ramp assembly 102 is telescoped outward, one longitudinal end can be positioned on an upper surface and the opposing longitudinal end can be placed on a lower surface. In the depicted example, the upper surface is the tailgate 104, and the lower surface is the ground 402.

The collapsible ramp assemblies 102 of the present disclosure can include a plurality of ramp members coupled together to facilitate the telescoping capabilities. An example of such a telescoping ramp assembly is described in U.S. Pat. No. 7,549,692, the entire disclosure of which is incorporated herein by this reference.

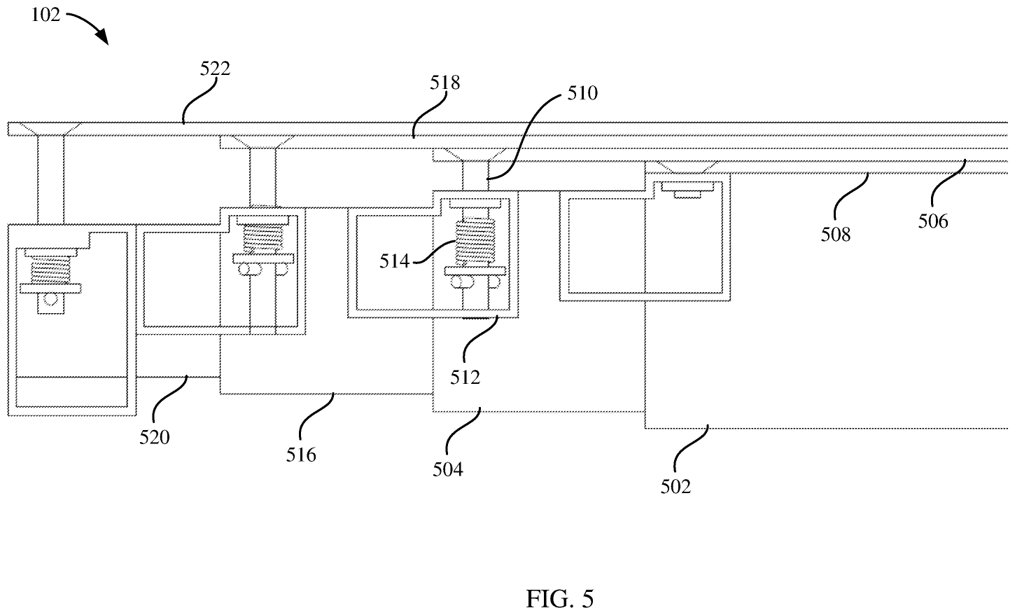

According to an aspect of the present disclosure, the collapsible ramp assemblies 102 converts between a collapsed, telescoped inward configuration and an extended, telescoped outward configuration. FIG. 5 is a side view of the collapsible ramp assembly 102 according to at least one example. In the example shown, the ramp assembly 102 includes four ramp members. The first ramp member 502 is at the first longitudinal end that is shown positioned on the tailgate in FIG. 4. A second ramp member 504 is telescoped into the first ramp member 502. As shown, the second ramp member 504 includes a top panel 506 that is positioned over a top panel 508 of the first ramp member 502. To facilitate positioning the top panel 506 of the second ramp member 504 over the top panel 508 of the first ramp member 502, the second ramp member 504 includes a rod 510 coupled to the top panel 506 of the second ramp member 504. The rod 510 extends from the top panel 506 into a housing 512, and a spring 514 is positioned relative to the rod 510 to exert a downward force on the rod 510. As shown, when the top panel 506 is pulled upward by the user, the spring 514 compresses.

Similar top panel, rod, and spring assemblies are also included with each of the remaining ramp members. For example, the third ramp member 516 is telescoped into the second ramp member 504, with a top panel 518 positioned over the top panel 506 of the second ramp member 504. Further, the depicted embodiment includes a fourth panel member 520 telescoped into the third ramp member 516, with a top panel 522 positioned over the top panel 518 of the third ramp member 516.

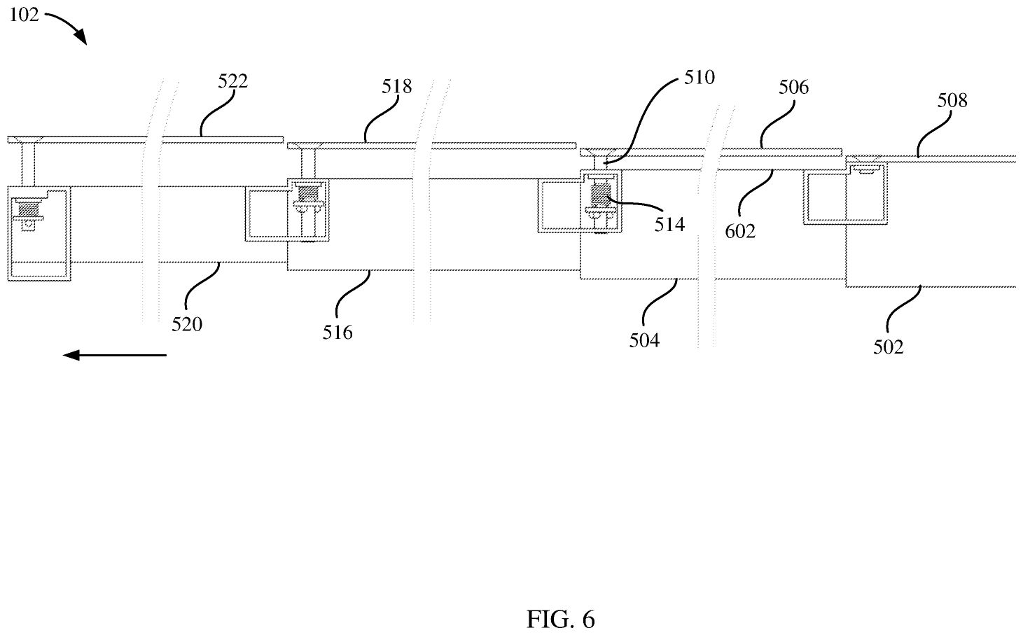

FIG. 6 is a side view of the collapsible ramp assembly when the ramp members 502, 504, 516, 520 are all telescoped outward. In this image, the top panels 508, 506, 518, 522 are still in their pulled upward positions. When the ramp members 502, 504, 516, 520 are fully extended, the springs, such as spring 514, exert a force on the respective rods, such as rod 510, to pull the respective top panel downward onto a respective top surface. For example, the spring 514 exerts a force on rod 510 to pull the top panel 506 of the second ramp member 504 onto a surface 602.

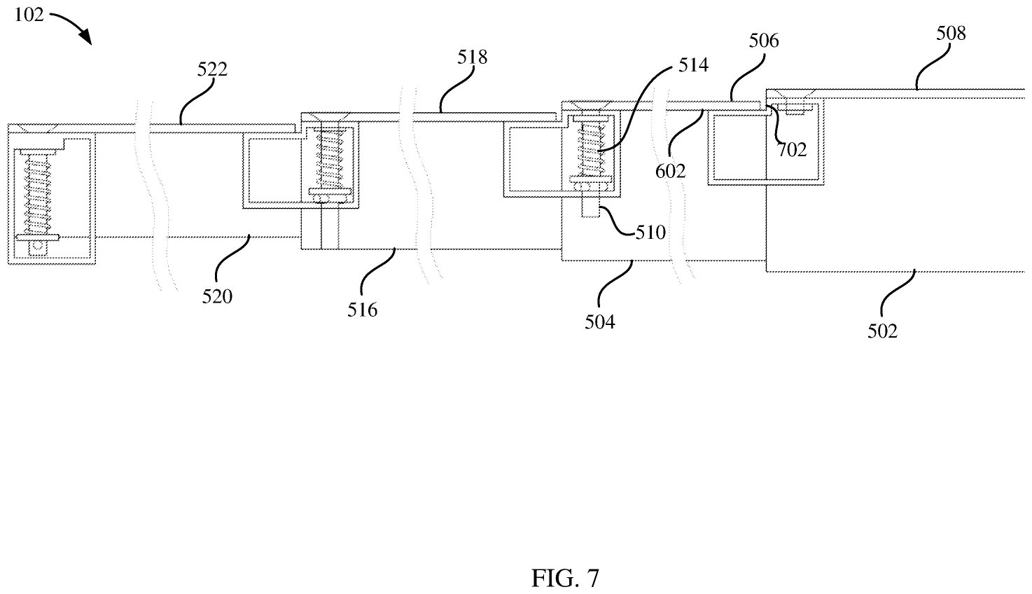

As shown in FIG. 7, when the top panels 506, 508, 518, 522 are pulled down onto a respective surface, such as surface 602, a step formed between ramp members locks the ramp members into the outward position. For example, top panel 506 is pulled down onto surface 602 by spring 514. A step 702 formed between the first ramp member 502 and the second ramp member 504 locks the top panel 506 of the second ramp member 504 from telescoping inward. That is, any attempt to collapse the second ramp member 504 into the first ramp member 502 will result in the top panel 506 colliding with the step 702 and inhibiting the collapse of the ramp members. As a result, the second ramp member 504 is locked into place in the extended position, and cannot be telescoped inward without the user pulling the top panel 506 upward until the top panel 506 is positioned above the top panel 508 of the first ramp member 502. In similar fashion, each ramp member 504, 516, 520 is locked into the extended position for use, and cannot accidentally telescope inward during use. When the user is finished with the collapsible ramp 102, each top panel 506, 518, 522 can be pulled upward until it is above the next respective top panel, as shown in FIG. 6. The ramp members can then be telescoped inward, as shown in FIG. 5, with the top panels respectively stacked over each other as depicted in FIG. 5.

Additional features of the present disclosure include methods of making a ramp assembly. Generally speaking, such methods may include forming a plurality of ramp members sized and configured to telescope into each other and comprising one or more of the features described and/or depicted in the present disclosure. For example, a method may include forming a first ramp member 502 including a first top panel 508, and forming a second ramp member 504. The second ramp member 504 may be formed to include a second top panel 506, a housing 512 below the second top panel 506, a rod 510 coupled to the second top panel 506 with the rod 510 extending from the second top panel 506 into the housing 512 to facilitate movement of the second top panel 506 up and down. Additionally, one or more embodiments may include a spring 514 positioned relative to the rod 510 to exert a force on the rod 510.

The second ramp member 504 can be coupled to the first ramp member 502 to telescope into and out from the first ramp member 502. In some examples, the second ramp member 504 can be coupled to the first ramp member 502 with the second top panel 506 positioned over the first top panel 508 when the second ramp member 504 is telescoped into the first ramp member 502. In such examples, the spring 514 may be compressed when the second top panel 506 is positioned over the first top panel 508.

Further, in some examples, the second ramp member 504 can be coupled to the first ramp member 502 with the second top panel 506 positioned adjacent a surface 602 of the second ramp member 504 when the second ramp member 504 is in a telescoped outward position. In such examples, the spring 514 may be at least partially decompressed when the second top panel 506 is positioned adjacent the surface 602 of the second ramp member 504.

Additionally, as described herein above, the second ramp member 504 can be coupled to the first ramp member 502 to form a step 702 between the first ramp member 502 and the second ramp member 504, and the second top panel 506 may be positioned adjacent to the step 702 when the second ramp member 504 is in a telescoped outward position.

Yet additional aspects of the present disclosure include methods of using a ramp assembly. According to one or more examples, such methods may include extending a plurality of ramp members in telescoping fashion, such as ramp members 502, 504, 516, 520. Each ramp member may be locked in the extended position by positioning a respective top panel associated with each ramp member against a respective top surface. For example, the top panel 506 may be positioned against the surface 602, and locked from telescoping inward by step 702, as described herein.

A top panel may be displaced away from the top surface for at least one ramp member, and the at least one ramp member may be telescoped into another ramp member with the top panel of the at least one ramp member positioned over the top panel of the other ramp member into which the at least one ramp member is telescoped. For example, as described herein, the top panel 506 of the second ramp member 504 can be displaced away from the surface 602, and the second ramp member 504 can be telescoped into the first ramp member 502 with the top panel 506 of the second ramp member 504 positioned over the top panel 508 of the first ramp member 502.

Employing one or more embodiments of the present disclosure, a user can utilize a ramp for moving objects between higher and lower surfaces, and can collapse the ramp when not in use.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A ramp assembly, comprising:
a first ramp member including a first top panel;
a second ramp member configured to telescope relative to the first ramp member, the second ramp member including
a second top panel,
a housing below the second top panel, and
a rod coupled to the second top panel, the rod extending from the second top panel into the housing.

2. The ramp assembly of claim 1, wherein the second top panel is positioned over the first top panel when the second ramp member is telescoped inward into the first ramp member.

3. The ramp assembly of claim 2, wherein the second ramp member further includes a spring positioned relative to the rod to exert a force on the rod, and the spring is compressed when the second top panel is positioned over the first top panel.

4. The ramp assembly of claim 1, wherein the second top panel is positioned adjacent a surface of the second ramp member when the second ramp member is in a telescoped outward position.

5. The ramp assembly of claim 4, wherein the second ramp member further includes a spring positioned relative to the rod to exert a force on the rod, and the spring is at least partially decompressed when the second top panel is positioned adjacent the surface of the second ramp member.

6. The ramp assembly of claim 1, further comprising a step formed between the first ramp member and the second ramp member, wherein the second top panel is positioned adjacent the step when the second ramp member is in a telescoped outward position.

7. The ramp assembly of claim 1, wherein the second ramp member further includes a spring positioned relative to the rod to exert a force on the rod.

8. A method of making a ramp assembly, comprising:
forming a first ramp member including a first top panel;
forming a second ramp member to include
a second top panel,
a housing below the second top panel, and
a rod coupled to the second top panel, the rod extending from the second top panel into the housing; and
coupling the second ramp member to the first ramp member to telescope into and out from the first ramp member.

9. The method of claim 8, wherein coupling the second ramp member to the first ramp member comprises:
coupling the second ramp member to the first ramp member with the second top panel positioned over the first top panel when the second ramp member is telescoped into the first ramp member.

10. The method of claim 9, wherein:
the second ramp member further comprises a spring positioned relative to the rod to exert a force on the rod; and
coupling the second ramp member to the first ramp member comprises coupling the second ramp member to the first ramp member with the spring compressed when the second top panel is positioned over the first top panel.

11. The method of claim 8, wherein coupling the second ramp member to the first ramp member comprises:
coupling the second ramp member to the first ramp member with the second top panel positioned adjacent a surface of the second ramp member when the second ramp member is in a telescoped outward position.

12. The method of claim 11, wherein:
the second ramp member further comprises a spring positioned relative to the rod to exert a force on the rod; and
coupling the second ramp member to the first ramp member comprises coupling the second ramp member to the first ramp member with the spring at least partially decompressed when the second top panel is positioned adjacent the surface of the second ramp member.

13. The method of claim 8, wherein coupling the second ramp member to the first ramp member comprises:
coupling the second ramp member to the first ramp member to form a step between the first ramp member and the second ramp member, wherein the second top panel is positioned adjacent the step when the second ramp member is in a telescoped outward position.

14. The method of claim 8, wherein forming the second ramp member further comprises:
forming the second ramp member to include a spring positioned relative to the rod to exert a force on the rod.

15. A method of using a ramp assembly, comprising:
extending a plurality of ramp members in telescoping fashion;
locking each ramp member in the extended position by positioning a respective top panel associated with each ramp member against a respective top surface;
displacing a top panel away from the top surface for at least one ramp member;
telescoping the at least one ramp member into another ramp member, wherein the top panel of the at least one ramp member is positioned over the top panel of the other ramp member into which the at least one ramp member is telescoped.

16. The method of claim 15, wherein a respective spring associated with the at least one ramp member is compressed when the top panel of the at least one ramp member is positioned over the top panel of the other ramp member into which the at least one ramp member is telescoped.

17. The method of claim 15, wherein a respective spring associated with the at least one ramp member is at least partially decompressed when the top panel of the at least one ramp member is positioned against the respective top surface of the at least one ramp member.

18. The method of claim 15, wherein locking each ramp member in the extended position by positioning a respective top panel associated with each ramp member against a respective top surface further comprises:
locking each ramp member in the extended position by positioning each respective top panel adjacent to a step.
